(19) United States
(12) Patent Application Publication
(10) Pub. No.: US 2004/0041999 A1
(43) Pub. Date: Mar. 4, 2004

(54) Method and apparatus for determining the geographic location of a target

(76) Inventors: John M. Hogan, Winter Springs, FL (US); Eytan Pollak, Oviedo, FL (US)

Correspondence Address: Eric R. Katz, LM Aero, Dept. 002n/0230, 86 S. Cobb Drive, Marietta, GA, 30063-0230, US

(21) Appl. No.: 10/229,999

(22) Filed: Aug. 28, 2002

(51) Int. Cl. G01C 1/00; G01B 11/26

(52) U.S. Cl. 356/141.5

(57) ABSTRACT

This invention generally relates to a method and apparatus for locating a target depicted in a real-world image that has a slant angle and vantage point location that are only approximately known using a virtual or synthetic environment representative of the real-world terrain where the target is generally located; and more particularly, to such a method and apparatus wherein a set of views of the virtual environment is compared with the real-world image of the target location for matching the simulated view that most closely corresponds to the real-world view in order to correlate the real-world image of the target with the selected simulated view in order to correctly locate the target in the virtual environment and thereby determine the exact location of the target in the real-world

### BACKGROUND OF THE INVENTION

1. Field of the Invention

This invention generally relates to a method and apparatus for locating a target depicted in a real-world image taken from an imaging device having a slant angle and focal plane orientation and location that are only approximately known; and more particularly, to such a method and apparatus using a virtual or synthetic environment representative of the real-world terrain where the target is generally located to generate a simulated view that closely corresponds to the real-world image in order to correlate the real-world image and synthetic environment view and hence to correctly locate the target in the virtual environment and thereby determine the exact location of the target in the real-world. 2. Background of the Invention

Historically, photography has been used by military intelligence to provide a depiction of an existing battlefield situation, including weather conditions, ground troop deployment, fortifications, artillery emplacements, radar stations and the like. One of the disadvantages to the use of photography in intelligence work is the slowness of the information gathering process. For example, in a typical photo-reconnaissance mission the flight is made; the aircraft returns to its base; the film is processed, then scanned by an interpreter who determines if any potential targets are present; the targets, if found, are geographically located, then the information relayed to a field commander for action. By the time that this process is completed the theatre of operation may have moved to an entirely different area and the intelligence, thus, becomes useless.

Recent advances in technology have resulted in the use of satellites, in addition to aircraft, as platforms for carrying radar, infrared, electro-optic, and laser sensors which have all been proposed as substitutes for photography because these sensors have the ability to provide real-time access to intelligence information. Today, a variety of assets and platforms are used to gather different types of information from the battlefield. For example, there are aircraft and satellites that are specifically dedicated to reconnaissance. Typically these types of platforms over-fly the battlefield. In addition, there are AWAC and STARS type aircraft that orbit adjacent a battlefield and gather information concerning air and ground forces by looking into the battlefield from a distance. Moreover, information can be gathered from forces on the ground, such as forward observers and the like as well as ground based stations that monitor electronic transmissions to gain information about the activities of an opponent. With the advances in communication technology it is now possible to link this information gathered from such disparate sources.

A more current development in battlefield surveillance is the use of Remotely Piloted Vehicles (RPV's) to acquire real-time targeting and battlefield surveillance data. Typically, the pilot on the ground is provided with a view from the RPV, for example, by means of a television camera or the like, which gives visual cues necessary to control the course and attitude of RPV and also provides valuable intelligence information. In addition, with advances in miniaturizing radar, laser, chemical and infrared sensors, the RPV is capable of carrying out extensive surveillance of a battlefield that can then be used by intelligence analysts to determine the precise geographic position of targets depicted in the RPV image.

One particular difficulty encountered when using RPV imagery is that the slant angle of the image as well as the exact location and orientation of the real focal plane (A flat plane perpendicular to and intersecting with the optical axis at the on-axis focus, i.e., the transverse plane in the camera where the real image of a distant view is in focus.) of the camera capturing the image are only approximately known because of uncertainties in the RPV position (even in the presence of on-board GPS systems), as well as the uncertainties in the RPV pitch, roll, and yaw angles. For the limited case of near zero slant angles (views looking perpendicularly down at the ground), the problem is simply addressed by correlating the real-world image of the target with accurate two-dimensional maps made from near zero slant angle satellite imagery. This process requires an operator's knowledge of the geography of each image so that corresponding points in each image can be correlated.

Generally, however, this standard registration process does not work without additional mathematical transformations for imagery having a non-zero slant angle because of differences in slant angles between the non-zero slant angle image and the vertical image. Making the process even more difficult is the fact that the slant angle as well as the orientation and location of the focal plane of any image provided by an RPV can only be approximately known due to the uncertainties in the RPV position as noted above.

### SUMMARY OF THE INVENTION

Accordingly, it is an object of the present invention to provide a method and apparatus for determining the exact geographic position of a target using real-world imagery having a slant angle and focal plane orientation and location that are only generally known.

To accomplish this result, the present invention requires the construction of a virtual environment simulating the exact terrain and features (potentially including markers placed in the environment for the correlation process) of the area of the world where the target is located. A real-world image of the target and the surrounding geography is correlated to a set of simulated views of the virtual environment. Lens or other distortions affecting the real-world image are compensated for before comparisons are made to the views of the virtual environment. The members of the set of simulated views are selected from an envelope of simulated views large enough to include the uncertain slant angle as well as location and orientation of the real focal plane of the real-world image at the time that the image was made. The simulated view of the virtual environment with the highest correlation to the real-world image is determined automatically or with human intervention and the information provided by this simulated view is used to place the target shown in the real-world image at the corresponding geographic location in the virtual environment. Once this is done, the exact location of the target is known.

Therefore it is another object of the present invention to provide a method and apparatus for determining the exact location of a target depicted in a real-world image having a slant angle and focal plane location and orientation that are only approximately known using a virtual or synthetic environment representative of the real-world terrain where the target is generally located wherein a set of views of the virtual environment each having a known slant angles as well as focal plane orientation and location is compared with the real-world image to determine which simulated view most closely corresponds to the real-world view and then correlating the real-world image of the target with the selected simulated view to correctly locate the target in the virtual environment and thereby determine the exact geographic location of the target in the real-world.

These and other advantage objects and features of the present invention are achieved, according to one embodiment of the present invention, by an apparatus for determining the precise geographic location of a target located on a battlefield, the apparatus comprising: at least one information gathering asset having a sensor for generating a real-world image of the target on the battlefield, wherein the image has a slant angle and focal plane orientation and location that are only approximately known; means for removing lens or other distortions from the image; a communications system for conveying images from the information gathering asset to the apparatus; a computer having a display; a digital database having database data representative of the geography of the area of the world at the battlefield, wherein the computer accesses the digital database to transform said database data and create a virtual environment simulating the geography of battlefield that can be view in three-dimensions from any vantage point location and slant angle; means for generating a set of simulated views of the virtual environment, the set of simulated views being selected so as to include a simulated view having about the same slant angle and focal plan orientation and location as the real-world image; means for selecting the simulated view that most closely corresponds to the real-world image; and means for correlating the real-world image of target with the selected simulated view of the virtual environment to correctly locate the target in the virtual environment and thereby determine the exact geographic location of the target in the real-world.

In certain instances the real-world image transmitted from the RPV may be of a narrow field of view (FOV) that only includes the target and immediate surroundings. In such cases the image may contain insufficient data to allow correlation with any one of the set of simulated views of the virtual environment. In accordance with further embodiments of the apparatus of the present invention, this situation is resolved in two ways:

1) With a variable field of view RPV camera which expands to the wider FOV after the target has been identified. At the wider FOV the correlation with the simulated view of the battlefield is made; or

2) Through the use of two cameras rigidly mounted to one another such that their bore-sights align, one camera has a FOV suitable for identifying targets; i.e., the target consumes a large fraction of the FOV. The second camera has a FOV optimized for correlation with the simulated views of the battlefield.

According to a further embodiment of the present invention there is also provided a method for determining the geographic location of a target on a battlefield, the method comprising the steps of: populating a digital database with database data representative of the geography of the battlefield where the target is generally located; generating a real-world image of the target on the battlefield, wherein the image has a slant angle and focal plane orientation and location that are only approximately known; correcting for lens or other distortions in the real-world image of the target; transforming the digital database to create a virtual environment simulating the geography of battlefield that can be viewed in three-dimensions from any vantage point location and any slant angle; generating a set of simulated views of the virtual environment, the views of the set being selected so as to include a view having about the same slant angle and focal plane orientation and location of the real-world image; selecting the simulated view that most closely corresponds to the real-world image; and correlating the real-world image of target with the selected simulated view of the virtual environment to locate the target in the virtual environment and thereby determine the exact geographic location of the target in the real-world.

### BRIEF DESCRIPTION OF THE DRAWINGS

FIG. 1 is a block diagram representing one embodiment of the apparatus of the present invention;

FIG. 2 depicts the position of the focal plane of a stealth view of a virtual environment representation of a battlefield;

FIG. 3 illustrates that all non-occulted points in the virtual environment that are within the stealth view field-of-view will map onto the stealth view focal plane;

FIG. 4 is a real-world image of a target and the surrounding geography;

FIG. 5 is a simulated view of the real-world image of FIG. 4;

FIG. 6 is a real-world image which has undergone edge detection to generate an image in which each pixel has a binary value;

FIGS. 7 and 8 depict simulated images selected from the set of stealth views where the simulated view is only made up of edges or where standard edge detections has been applied to the stealth views;

FIG. 9 illustrates a further embodiment of the present invention for addressing instances where the real-world image a narrow field of view (FOV) and contains insufficient surrounding information to match with a simulated view of the virtual environment; and

FIG. 10 is a block diagram illustrating the steps of one embodiment of the method of the present invention for determining the geographic location of a target on a battlefield.

### DETAILED DESCRIPTION OF THE PREFERED EMBODIMENT(S)

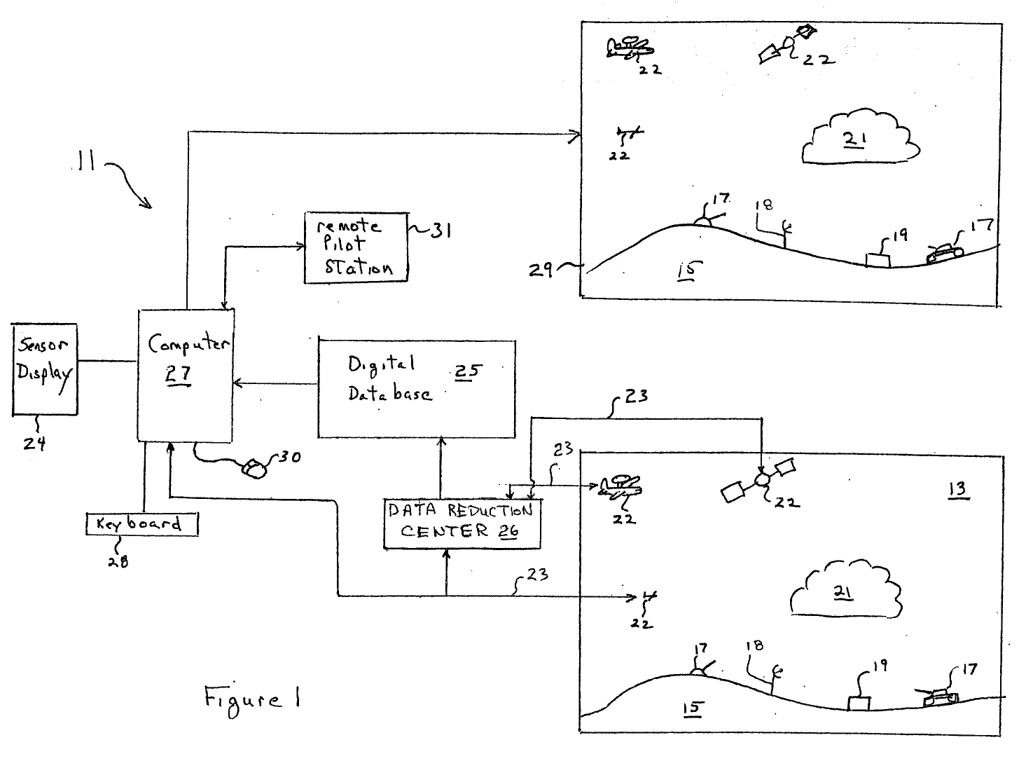

Referring to FIG. 1, a block diagram is provided that depicts the elements of one embodiment of an apparatus, generally indicated at 11, for determining the exact location of a target on a battlefield 13. As shown in FIG. 1, the battlefield has terrain 15, targets 17 at different locations, man-made structures 19, electronic warfare assets 18 as well as atmospheric conditions 21, such as natural conditions like water vapor clouds, or man-made conditions such smoke or toxic gas-like clouds that may or may not be visible to the naked eye. The apparatus 11 includes at least one information gathering asset 22 having one or more sensors for gathering information from the battlefield 13 in real-time. The information gathering asset 22 comprises, for example, an AWAC or the like, a satellite, a Remotely Piloted Vehicle (RPV) as well as forward observers (not shown) and any other known arrangement for gathering information from a battlefield. The one or more sensors on the asset 22 comprise different types of sensors, including any known sensor arrangement, for example, video, infrared, radar, GPS, chemical sensors (for sensing a toxic or biological weapon cloud), radiation sensors (for sensing a radiation cloud), electronic emitter sensors as well as laser sensors.

A communications system 23 is provided for conveying information between any of the information-gathering assets 22 and the apparatus 11. Information gathered from sensors on any one of the information gathering assets 22 can be displayed on sensor display 24 for viewing by an operator (not shown) of the apparatus 11 in real-time or directly inputted into a digital database 25. As will be more fully described hereinafter, the data that will populate the digital database include, for example, battlefield terrain, man-made features and, for example, markers if placed in the real-world environment for the purpose of correlating the stealth and real image as further described hereinafter in connection the further embodiments of the present invention.

The digital database is initially populated with existing database data for generating a simulated three-dimensional depiction of the geographic area of the battlefield 13. The technologies for generating such a virtual or synthetic environment database for representing a particular geographic area are common. Typical source data inputs comprise terrain elevation grids, digital map data, over-head satellite imagery at, for example, one-meter resolution and oblique aerial imagery such as from an RPV as well as digital elevation model data and/or digital line graph data from the U.S. Geological Survey. From these data a simulated three-dimensional virtual environment of the battlefield 13 is generated. Also added to the database may be previously gathered intelligence information regarding the situation on the battlefield.

Thus, the initial database data comprises data regarding the geographic features and terrain of the battlefield, as well as, existing man-made structures such as buildings and airfields,

A computer 27, having operator input devices, such as, for example, a keyboard 28 and mouse or joystick 30, is connected to the sensor display 24 as well as a virtual battlefield display 29.

The computer 27 accesses the digital database 25 to transform said database data and provide a virtual, three-dimensional view of the battlefield 13 on the virtual battlefield display 29. Since each of the information gathering assets transmit GPS data, it is also possible to display the location of each of these assets 22 within the virtual, three-dimensional view of the battlefield

As is well known in the art, the computer 27 has software that permits the operator, using the keyboard 28 and mouse or joystick 30, to manipulate and control the orientation, position and magnitude of the three-dimensional view of the battlefield 13 on the display 29 so that the battlefield 13 can be viewed from any vantage point location and at any slant angle.

One particular problem that the one or more intelligence analysts comprising the data reduction center 26 will have with entering the received, updated information into the database is determining the precise geographic-positioning of targets in the simulated, three-dimensional representation of the battlefield. This is acutely problematic when using, for example, RPV imagery (or other imagery) taken at arbitrary slant angles. For the limited case of near zero slant angles, the problem is addressed by correlating the image of the target provided by, for example, RPV imagery with accurate two dimensional maps made from near zero slant angle satellite imagery. Generally, however, this standard registration process does not work in real time with imagery having a non-zero slant angle because the differences in slant angles between the non-zero slant angle image and the satellite image will result in a non-alignment and cause an incorrect placement of the target or weather condition on the simulated three-dimensional view of the battlefield

However, the present invention provides a solution to this vexing problem of locating the exact position of an object seen in real-time imagery taken with a non-zero slant angle. This solution uses a set of views of the simulated, three-dimensional battlefield taken from different vantage point locations and with different slant angles. The envelope of this set of views is selected to be large enough to include the anticipated focal plane orientation and location (RPV orientation and location) and slant angle of the image of the target provided from the RPV. Using technology that is well known, the RPV image is corrected for lens or other distortions and is then compared with each view of the set of views of the simulated, three-dimensional battlefield and a determination is made to as to which simulated view most closely correlates to the view from the RPV.

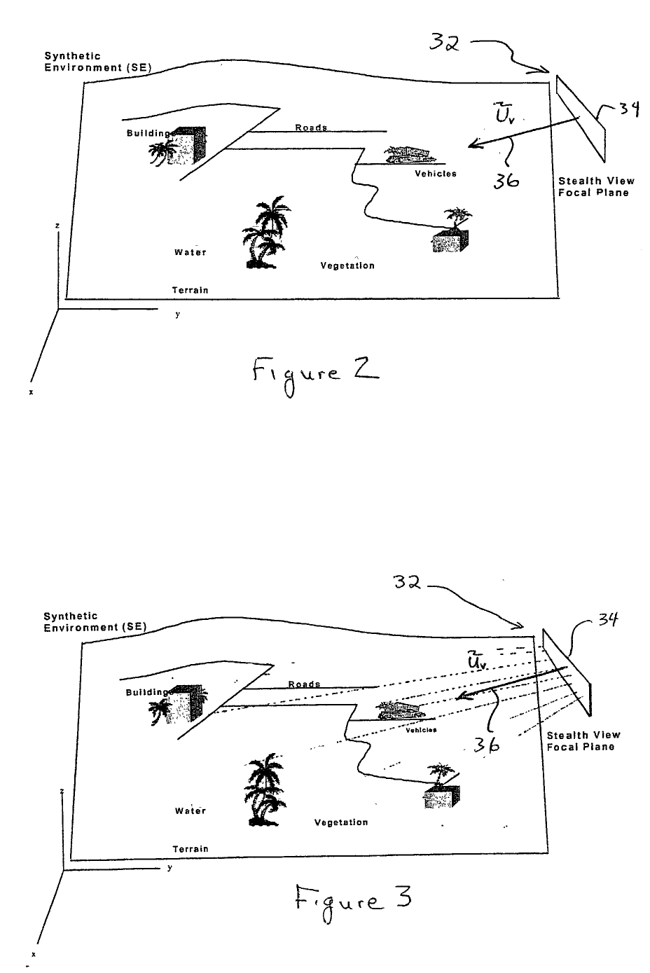

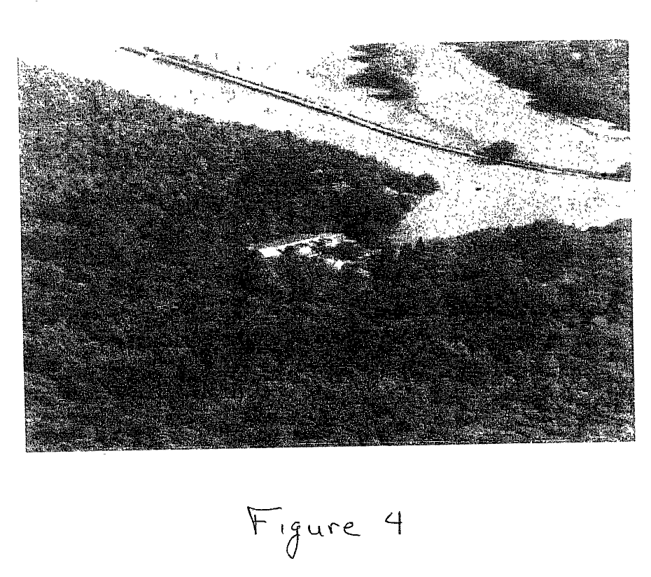

FIG. 2 conceptually shows the elements of a simulated, three-dimensional view of the battlefield in which the world is represented via a polygonalization process in which all surfaces are modeled by textured triangles of vertices (x, y, z). This current technology allows for the visualization of roads, buildings, water features, terrain, vegetation, etc. from any direction and at any angle. If the viewpoint is not associated with a particular simulated vehicle, trainee, or role player within the three-dimensional battlefield, it will be referred to hereinafter as a “stealth view.” A representation of the stealth view is generally shown at 32 in FIG. 2 and comprises a focal plane 34, the location and orientation of which is determined by the coordinates (xᵥ, yᵥ, zᵥ) of the centroid (at the focal point) of the stealth view focal plane 34 and a unit vector Uᵥ 36 (on, for example, the optical axis so that the unit vector is bore-sighted at the location that the stealth view is looking) which is normal to the stealth view focal plane 34 and intersects the focal plane 34 at a pixel, for example, the centroid of the focal plane as illustrated in FIG. 3.

As can be seen from FIG. 3, all non-occulted points in the simulated three-dimensional view within the stealth view field of view map onto a location on the stealth view focal plane 34. Correspondingly, all points on the stealth view focal plane 34 map onto locations in the simulated three-dimensional battlefield. This last statement is important as will be more fully discussed below.

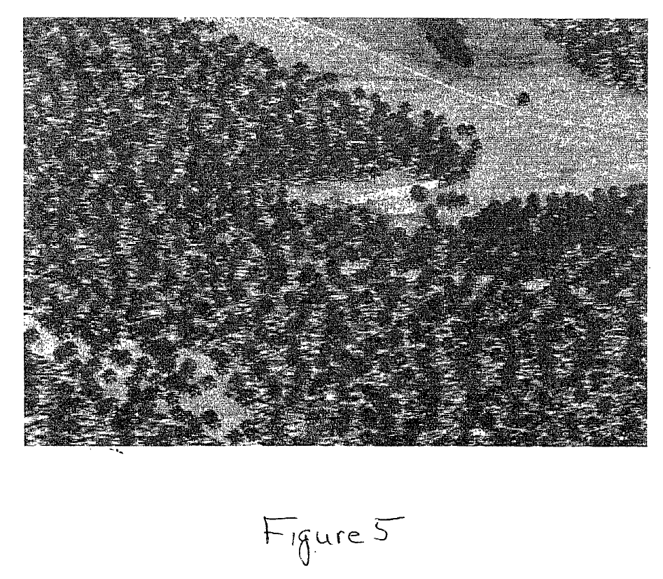

Consider an image provided by an RPV or any other real-world image for which the slant angle as well as the location and orientation of the real focal plane are only approximately known. The approximate location of the focal plane is driven by uncertainties in the RPV position (even in the presence of on-board GPS systems), the uncertainty in RPV pitch, roll, and yaw angles, and the uncertainty of the camera slant angle. Such an image, designated as image I, after it is corrected for lens or other distortions, is shown in FIG. 4. For the sake of discussion, the round spot slightly off center will be considered the target. With current technology, it is possible to create a simulated, three-dimensional view representing the real-world depicted by the real-world image I of FIG. 4 such that inaccuracies in the geometric relationship in the simulated view as compared to the real-world view can be made arbitrarily close to zero. The location of the RPV and its equivalent focal plane can also be placed in the simulated, three-dimensional battlefield at the most likely position subject to a statistically meaningful error envelope. The size of the error envelope depends on the RPV inaccuracies noted above.

A set of stealth views of the simulated, three-dimensional battlefield is then generated so as to include the range of uncertainty in the RPV focal plane orientation and location. This set of views shall be referred to as S. The set of views S are then correlated with the-real-world image received from the RPV. This correlation can be visually determined with human intervention or done with software that automatically compares mathematical representations of the image or both. Note that this correlation does not require knowledge (human or software) of the geographical content of each image, as is the case in the 2D registration process. (An embodiment of this invention that does require such knowledge is described later.) The simulated image of the set of simulated images S with the highest correlation is designated SH.

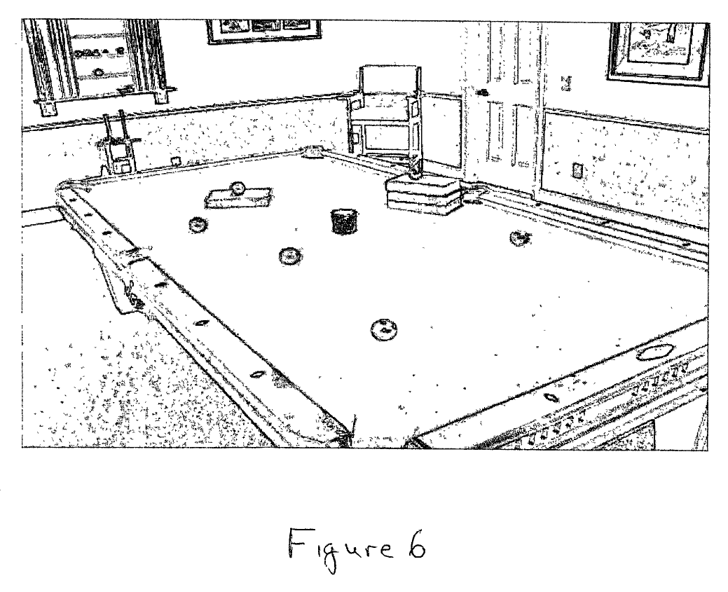

Referring to FIG. 5, simulated image SH most closely corresponding to real-world image I is shown. Note that the target shown in real-world image I is not present in simulated image SH. A pixel for pixel correspondence, however, now exists between images I and SH, the accuracy of which is only limited by the accuracy of the correlation process. The two-dimensional coordinates in image I that define the target are used to place the target at the appropriate location in simulated image SH. Since the slant angle and focal plane orientation and location of the simulated image SH are known, standard optical ray tracing mathematics are then used to determine the intersection of the vector UV from the target pixel of the stealth view focal plane of the image SH with the simulated three-dimensional battlefield terrain. This intersection defines the x, v, z coordinate location of the target in the simulated, three-dimensional battlefield and hence the coordinate location of the target in the real world. The accuracy of the calculation of the target's real-world location is determined by the geometric accuracy of the representation of the simulated, three-dimensional battlefield, the distortion removal process, and the correlation process.

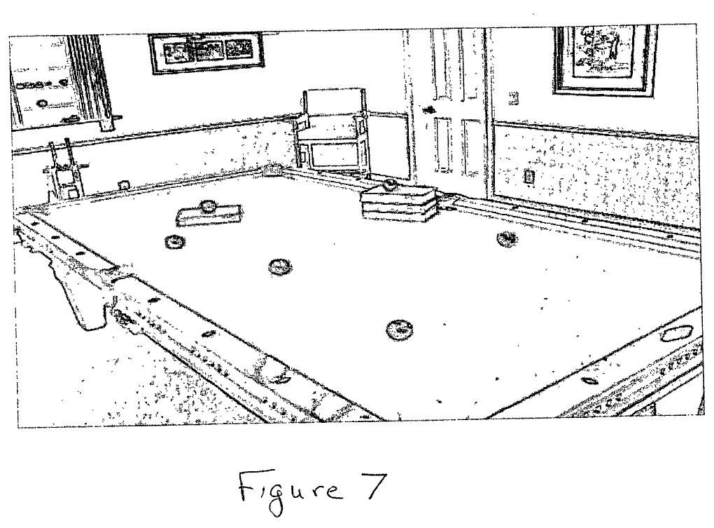

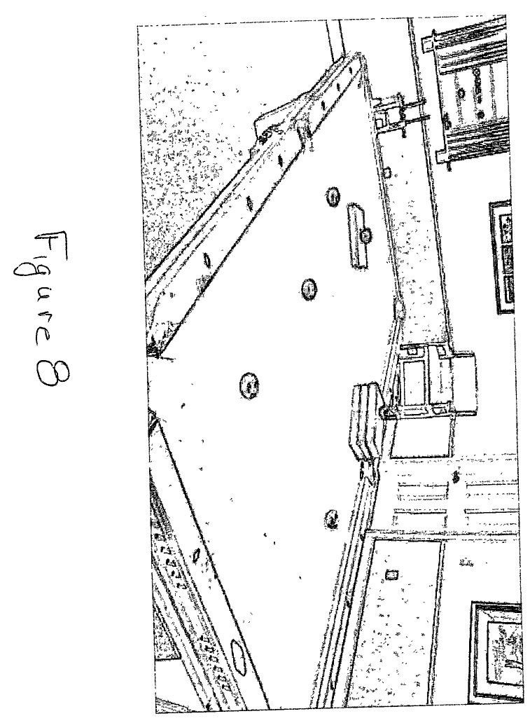

In the process described above, the correlation of image I to the set of stealth views S can be accomplished by a human viewing the images using various tools such as overlays, photo zoom capabilities, and “fine” control on the stealth view location. The optical correlation process can also be automated using various standard techniques currently applied in the machine vision, pattern recognition and target tracking arts. Typically, these automated techniques first apply edge detection to generate an image in which pixels have a binary value. FIG. 6 depicts such an image of a billiard table in which the glass shall be considered a target. FIGS. 7 and 8 depict simulated images selected from the set of stealth views S where the simulated view is only made up of edges or where standard edge detections has been applied to the stealth views. Exhaustive automated comparisons can be made at the pixel level to determine that the simulated image of FIG. 8 is the best match with the image of FIG. 6.

The pixels which define the glass are transferred to the simulated image of FIG. 8 and the calculation is made to determine the x, y, z coordinates of the glass. Comparing the degree of correlation between the images comprising the set of stealth views S and the image of FIG. 6 can be combined with standard search algorithms to pick successively better candidates for a matching image from the set of simulated images S without the need to compare each member of the set S to the image of FIG. 6.

In a further embodiment of the matching process, a variation of the basic targeting process is proposed in which markers, such as thermal markers, are placed in the real world at the region where targets are expected to be located. These thermal markers simply report their GPS location via standard telemetry. A simulated, three-dimensional depiction of the region is created based only on non-textured terrain and the models of the thermal markers located within the simulated region via their GPS telemetry. A real-world distortion corrected image I is then made of the region using an IR camera. The thermal markers and hot targets will appear in the real-world image 1. Filtering can be applied to isolate the markers by their temperature. A set of stealth views S is now made comprising simple images showing the thermal targets. The correlation process is now greatly simplified. Consider the billiard balls shown in FIGS. 6-8 to be the thermal markers and the glass as the target. The number of pixels required to confirm a matching alignment between the real-world image I and one of the simulated images from the set of stealth views S is greatly reduced. The transfer of the target from the real-world image I to the matching stealth view image and the back calculation for locating the target in the simulated, three-dimensional depiction of the region and then the real-world remain the same.

In a further embodiment of the matching process, a stealth view approximately correlated to the RPV image and the RPV image itself are ortho-rectified relative to one another. This standard process requires identifying points in each image as corresponding to one another (e.g., known landmarks such as road intersections and specific buildings). Coordinate transformations are calculated which allow these points to align. These coordinate transformations can be used to generate aligned bore-sights between the stealth view and real-world image from the RPV (and the process described above proceeds) or can be used to directly calculate the position of the target. Although the ortho-rectification process does not require exhaustive matches of the stealth view to the RPV image, it does require knowledge of which points are identical in each image.

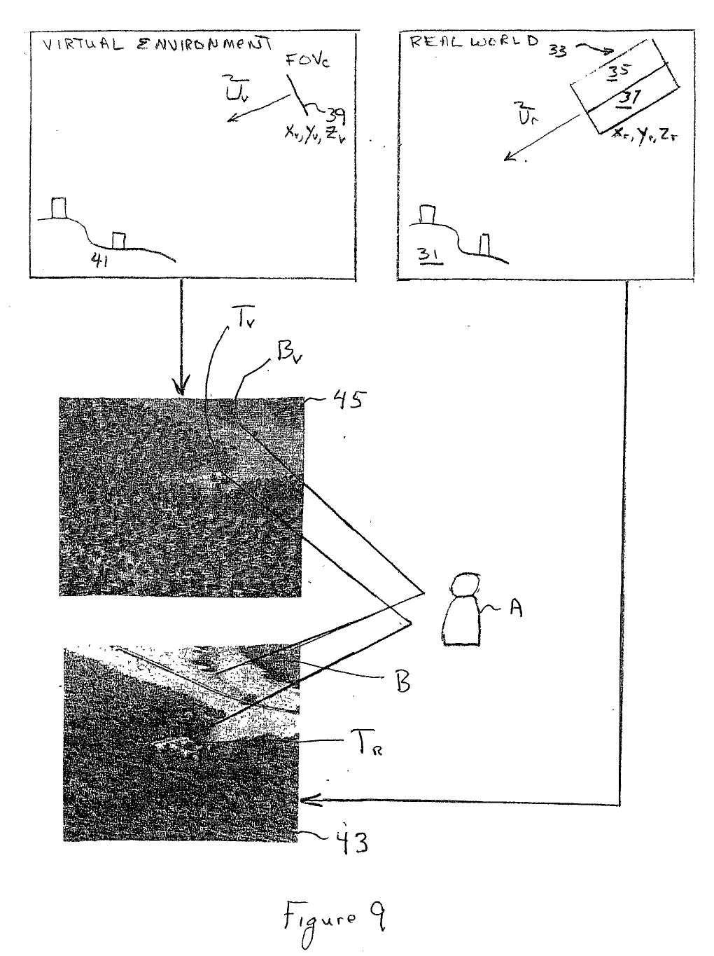

In a further embodiment of the present invention, the techniques described above are combined. This implementation is shown in FIG. 9. In the real-world 31, a camera assembly 33 located on, for example, a RPV comprises a targetry camera 35 (small FOV) and a correlation camera 37 with a relatively large FOV (FOV_{c}). These cameras are bore-sight aligned. The approximate location xᵣ, yᵣ, zᵣ and unit vector Uᵣ describing the assembly's orientation are used to generate a stealth view 39 having a relatively large field of view (FOV_{c}) of the virtual environment 41. The stealth view 39 is given the same approximate location (location xᵥ, yᵥ, zᵥ) and the same approximate orientation (unit vector Uᵥ) in the virtual environment 41 as that corresponding to the approximate location and orientation of the cameral assembly 33 in the real-world 31. An operator A continuously views the real-world image 43 from the correlation camera 37 and the stealth view image 45. The operator A identifies points Bᵣ, Tᵣ and Bᵥ, Tᵥ on the real-world image 43 and stealth view image 45 that respectively represent the same physical entities (intersections, buildings, targets, etc.) in each of the images 43, 45.

Using these points Bᵣ, Tᵣ and Bᵥ, Tᵥ and a standard ortho-rectification process it is possible to align the bore-sight (unit vector Uᵥ) of stealth view image 45 to the bore-sight (unit vector Uᵣ) of the real-world image 43 transmitted from the RPV. A continuous ray trace calculation from the center pixel of the stealth view 39 to the three-dimensional, virtual environment 41 is used to calculate the coordinates (xᵥ, yᵥ, zᵥ) of the terrain at which the boresight (unit vector Uᵥ) of the stealth view 39 is currently pointing (current stealth view). The current stealth view image 45 is also continuously correlated (e.g., with edge detection correlation) to the current real-world image 43. This correlation is now used to provide a quality metric rather than image alignment that in this embodiment is done via the relative ortho-rectification. When the target is identified and centered in the image generated from the small FOV camera 37, its coordinates are immediately given by the coordinates of the terrain at which the bore-sight (unit vector Uᵥ) of the stealth view is currently pointing. The accuracy of these coordinates is controlled by the accuracy of the representation of the real-world in the virtual environment and the accuracy of the relative ortho-rectification process.

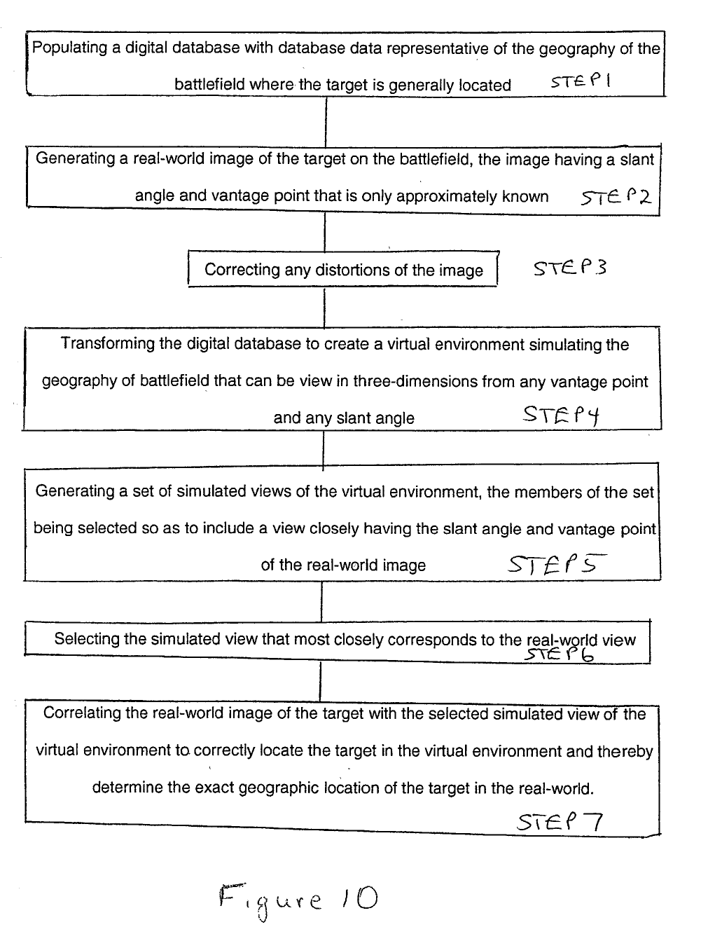

Referring to FIG. 10, a block diagram is provided that illustrates the steps of one embodiment of a method for determining the location of a target on a battlefield. In step 1, a digital database is populated with database data representative of the geography of the battlefield where the target is generally located. In step 2, a real-world image of the target on the battlefield is generated, the image having a slant angle and vantage point location that is only approximately known. In step 3, the image is corrected for lens or other distortions. In step 4, the digital database is transformed to create a virtual environment simulating the geography of battlefield that can be viewed in three-dimensions from any vantage point location and any slant angle. In step 5, a set of simulated views of the virtual environment is generated, the members of the set being selected so as to include a view closely having the slant angle and vantage point location of the real-world image. In step 6, the simulated view that most closely corresponds to the real-world view is selected; and in step 7, the real-world image of the target is correlated with the selected simulated view of the virtual environment to correctly locate the target in the virtual environment and thereby determine the exact geographic location of the target in the real-world.

Although the present invention has been described in terms of specific exemplary embodiments, it will be appreciated that various modifications and alterations might be made by those skilled in the art without departing from the spirit and scope of the invention as specified in the following claims.

What is claimed is:

1. An apparatus for determining a real-world location of a target on a battlefield, the apparatus comprising:
at least one information gathering asset having a sensor for generating a real-world image of the target on the battlefield, wherein the image has a slant angle and focal plane orientation and location that are only approximately known;
a communications system for conveying images from the information gathering asset to the apparatus;
a computer having a display;
a digital database having database data representative of the geography of the battlefield terrain, wherein the computer accesses the digital database to transform said database data and create a virtual environment simulating the geography of battlefield that can be viewed in three-dimensions from any direction, vantage point location and slant angle;
image generating means for generating a set of simulated views of the virtual environment, the set of simulated views being selected so as to include a simulated view having about the same slant angle and focal plane orientation and location as those of the real-world image;
selecting means for selecting the simulated view that most closely corresponds to the real-world image, said selected simulated view having a known slant angle and focal plane orientation and location and a near pixel-to-pixel correspondence with the real-world image; and
correlating means for correlating the real-world image of the target with the selected simulated view of the virtual environment to determine a virtual location of the target in the selected simulated view that corresponds to the location of the target depicted in the real-world image;
placement means for placing a virtual representation of the real-world image of the target in the selected simulated view at the corresponding virtual location of the target in the selected simulated view; and
target-location determining means for determining geographic coordinates of the location of the virtual representation of the target in the virtual environment to thereby determine the exact geographic location of the target in the real-world.

2. An apparatus according to claim 1, wherein the selecting means for selecting the simulated view that most closely corresponds to the real-world image includes at least one of: a human that makes the selection visually and a software driven computer that makes the selection by comparing mathematical representations of the simulated views and real-world image.

3. An apparatus according to claim 1, further comprising a target-location display means for displaying geographic coordinates of the location of the target in human readable form.

4. An apparatus according to claim 1, the geographic coordinates displayed by the target-location display means include the elevation, longitude and latitude of the location of the target in the real-world.

5. An apparatus according to claim 4, wherein the placement means uses the coordinates of the pixels comprising the target in the real-world image to place the target at a corresponding location in the selected simulated view.

6. An apparatus according to claim 5, wherein the target-location determining means uses standard optical ray tracing mathematics to determine an intersection of a unit vector UV extending normally from a target pixel of the focal plane of the selected simulated view and the simulated three-dimensional battlefield terrain, wherein the intersection defines an x, y, z coordinate location of the target on the simulated, three-dimensional battlefield and hence the coordinate location of the target in the real-world.

7. An apparatus according to claim 1, further comprising markers that are placed in the real-world in the region of the battlefield where targets are expected to be located and are viewable by the sensor on the information gathering asset so that the real-world image of the target will show the markers, wherein the location of each of the markers in the real-world is known and inputted into the database.

8. An apparatus according to claim 7, wherein the computer transforms the digital database data to create a virtual environment which depicts the battlefield using non-textured terrain and the location of the markers on the battlefield.

9. An apparatus according to claim 8, the image generating means generates a set of simulated views of the non-textured terrain of the battlefield showing the markers.

10. An apparatus according to claim 9, the selecting means uses the markers to select the simulated view of the non-textured terrain that most closely corresponds to the real-world image to reduce the number of pixels required to confirm a matching alignment between the real-world image and the matching simulated view.

11. An apparatus according to claim 7, wherein the selecting means includes ortho-rectification means for ortho-rectifying the simulated views and the real-world image relative to one another using the markers in each image which correspond to one another wherein coordinate transformations are calculated by the ortho-rectification means that allow these markers in each image to align to determine which simulated view most closely corresponds to the real-world image.

12. An apparatus according to claim 7, wherein the markers are thermal markers.

13. An apparatus according to claim 1, wherein the selecting means includes ortho-rectification means for ortho-rectifying the simulated views and the real-world image relative to one another using identifying features in each image which correspond to one another wherein coordinate transformations are calculated by the ortho-rectification means that allow these identifying features in each image to align to determine which simulated view most closely corresponds to the real-world image.

14. An apparatus according to claim 13, wherein the identifying features comprise at least one of natural and man-made landmarks found on the battlefield,

15. An apparatus according to claim 1, further comprising an image distortion removing means for removing any distortions of the real-world image.

16. An apparatus according to claim 1, wherein the at least one sensor comprises a targeting sensor for primarily imaging a target and a correlation sensor for imaging the area surrounding the target, wherein the sensors are bore-sight aligned and the correlation sensor has a larger field of view than the field of the targeting sensor.

17. An apparatus according to claim 16, wherein the real-world image from the correlation sensor is used by the selecting means to select a simulated view of the virtual environment that most closely corresponds to the real-world image of the correlation sensor, said simulated view having a known slant angle and focal plane orientation and location.

18. An apparatus according to claim 17, the location of the target shown in the image from the targeting sensor is determined by the target-location determining means using a continuous ray trace calculation to determine an intersection of a unit vector UV extending normally from a center pixel of the focal plane of the selected simulated view and the simulated three-dimensional battlefield terrain, wherein the intersection defines an x, y, z coordinate location of the target on the simulated, three-dimensional battlefield and hence the coordinate location of the target in the real-world.

19. An apparatus for determining the precise geographic location of a target located on a battlefield, the apparatus comprising:
at least one information gathering asset having a sensor for generating a real-world image of the target on the battlefield, wherein the image has a slant angle and focal plane orientation and location that are only approximately known;
a communications system for conveying images from the information-gathering asset to the apparatus;
a computer having a display;
a digital database having database data representative of the geography of the battlefield terrain, wherein the computer accesses the digital database to transform said database data and create a virtual environment simulating the geography of battlefield that can be viewed in three-dimensions from any direction, vantage point location and slant angle;
image generating means for generating a simulated view of the virtual environment using the approximately known slant angle and focal plane orientation and location of the real-world image;
identifying means for identifying landmarks in the simulated view that correspond to equivalent landmarks in the real-world image;
ortho-rectification means for ortho-rectifying the simulated view and the real-world image using the equivalent landmarks in the simulated view and the real-world image; and
correlating means for correlating the ortho-rectified real-world image of the target with the ortho-rectified simulated view of the virtual environment to determine a virtual location of the target in the selected simulated view that corresponds to the location of the target depicted in the real-world image;
placement means for placing a virtual representation of the real-world image of the target in the selected simulated view of the corresponding virtual location of the target in the selected simulated view; and
target-location determining means for determining the geographic location of the virtual representation of the target in the virtual environment and thereby determine the geographic location of the target in the real-world.

20. An apparatus according to claim 19, wherein correlating means continuously correlates the simulated view to the real-world image using the ortho-rectification means to provide a quality metric so that when the target is identified and centered in the real-world image, the coordinates of the target are given by the coordinates of the terrain at which the simulated view is currently bore-sighted.

21. A method for determining the geographic location of a target on a battlefield, the method comprising the steps of:
populating a digital database with database data representative of the geography of the battlefield where the target is generally located;
generating a real-world image of the target on the battlefield, wherein the image has a slant angle and focal plane orientation and location that are only approximately known;
transforming the digital database to create a virtual environment simulating the geography of battlefield that can be view in three-dimensions from any vantage point location and any slant angle;
generating a set of simulated views of the virtual environment, the set of simulated views being selected so as to include a view having about the same slant angle and focal plane orientation and location of the real-world image;
selecting the simulated view that most closely corresponds to the real-world image;
correlating the real-world image of the target with the selected simulated view of the virtual environment to determine a virtual location of the target in the selected simulated view that corresponds to the location of the target depicted in the real-world image;
placing a virtual representation of the real-world image of the target in the selected simulated view at the corresponding virtual location of the target; and
determining the geographic coordinates of the virtual location of the target in the virtual environment to thereby determine the exact geographic location of the target in the real-world.

22. A method according to claim 21, further comprising the step of correcting any distortions of the real-world image.

23. A method for determining the precise geographic location of a target located on a battlefield, the method comprising the steps of:
populating a digital database with database data representative of the geography of the battlefield where the target is generally located;
generating a real-world image of the target on the battlefield, wherein the image has a slant angle and focal plane orientation and location that are only approximately known;
transforming the digital database to create a virtual environment simulating the geography of battlefield that can be view in three-dimensions from any vantage point location and any slant angle;
generating a simulated view of the virtual environment having the same approximately known slant angle and focal plane orientation and location as that of the real-world image;
identifying landmarks in the simulated view that correspond to equivalent landmarks in the real-world image;
ortho-rectifying the simulated view and the real-world image using the equivalent landmarks in the simulated view and the real-world image; and
correlating the ortho-rectified real-world image of the target with the ortho-rectified simulated view of the virtual environment to correctly locate the target in the virtual environment and thereby determine the exact geographic location of the target in the real-world.

24. A method according to claim 23, wherein the simulated view is continuously correlated to the real-world image to provide a quality metric so that when the target is identified and centered in the real-world image, the coordinates of the target are given by the coordinates of the terrain at which the simulated view is currently pointing.
